(19) United States
(12) Patent Application Publication
(10) Pub. No.: US 2015/0214670 A1
(43) Pub. Date: Jul. 30, 2015

(54) ELECTRICAL CONNECTOR HAVING IMPROVED ANTI-EMI PERFORMANCE

(71) Applicant: FOXCONN INTERCONNECT TECHNOLOGY LIMTED, Grand Cayman (KY)

(72) Inventors: YONG-SONG DI, Kunshan (CN); XIAO FAN, Kunshan (CN); JUN CHEN, Kunshan (CN); JERRY WU, Irvine, CA (US)

(21) Appl. No.: 14/605,958

(22) Filed: Jan. 26, 2015

(30) Foreign Application Priority Data
Jan. 24, 2014 (CN) 201410032293.1

(51) Int. Cl. H01R 13/6581

(52) U.S. Cl. CPC H01R 13/6581

(57) ABSTRACT

An electrical connector (100) with an end connected with a cable (200) includes: an insulative housing (10) including a front face (102), a rear face (103), and a number of side faces (101); a number of contacts (20) mounted to the insulative housing; and a metal shell (30) enclosing the insulative housing. The metal shell includes a first metal shell (31), a second metal shell (32), and a third metal shell (3) cooperated to seal gaps between the insulative housing and the cable.

### BACKGROUND OF THE INVENTION

1. Field of the Invention

The present invention relates to an electrical connector connected with a cable, and more particularly to an electrical connector having a metal shell.

2. Description of Related Arts

U.S. Pat. No. 8,500,489, issued on Aug. 6, 2013 to Lu et al., discloses an electrical connector connected with a cable. The electrical connector comprises an insulative housing, a plurality of contacts mounted to the insulative housing, and a metal shell enclosing the insulative housing. The metal shell comprises an upper shell and a lower shell mated with the upper shell. Both of the upper and the lower shell comprises a crimping portion for being crimped with the cable. There are gaps formed between the cable and the insulative housing. Therefore, the electrical connector has poor anti-EMI performance.

U.S. Publication No. 2013/0175080, published on Jul. 11, 2013 to Colahan, discloses an electrical connector connected with a cable. The electrical connector comprises a mating portion, a printed circuit board, and a metal shell enclosing the mating portion and the printed circuit board. The metal shell includes a top shell, a bottom mated with the top shell, and a micro crimp. The micro crimp comprises a round portion crimped with the cable and a pair of flat portions bearing against the printed circuit board. The flat portions need be accurately manufactured to fully seal the first and the second shells.

Hence, an improved electrical connector is desired to offer advantages over the related art.

### SUMMARY OF THE INVENTION

An object of the present invention is to provide an electrical connector without gaps between the cable and the insulative housing and has good anti-EMI performance.

To achieve the above-mentioned object, an electrical connector with an end connected with a cable comprises: an insulative housing comprising a front face, a rear face, and a plurality of side faces; a plurality of contacts mounted to the insulative housing; and a metal shell enclosing the insulative housing. The metal shell comprises a first metal shell, a second metal shell, and a third metal shell cooperated to seal gaps between the insulative housing and the cable. The first metal shell and the second metal cooperate to enclose the side faces. One of the first and the second metal shells comprises at least one extending portion disposed at a rear portion of the insulative housing, and the third metal shell comprises a circled portion for the cable to extend through and at least one side portion extending from the circled portion, the at least one extending portion and the at least one side portion cooperating to seal some of the gaps formed at a rear of the insulative housing.

According to the present invention, the metal shell comprises a first, second, and third metal shells cooperated with each other to seal gaps between the insulative housing and the cable.

### BRIEF DESCRIPTION OF THE DRAWING

FIG. 1 is a perspective view of an electrical connector connected with a cable in accordance with the present invention;

FIG. 2 is an exploded view of the electrical connector and the cable as shown in FIG. 1;

FIG. 3 is another exploded view of the electrical connector and the cable as shown in FIG. 2;

FIG. 4 is a perspective view of the electrical connector as shown in FIG. 1;

FIG. 5 is another perspective view of the electrical connector as shown in FIG. 4; and

FIG. 6 is a partly exploded view of the electrical connector as shown in FIG. 4.

### DETAILED DESCRIPTION OF THE PREFERRED EMBODIMENT

Reference will now be made in detail to a preferred embodiment of the present invention.

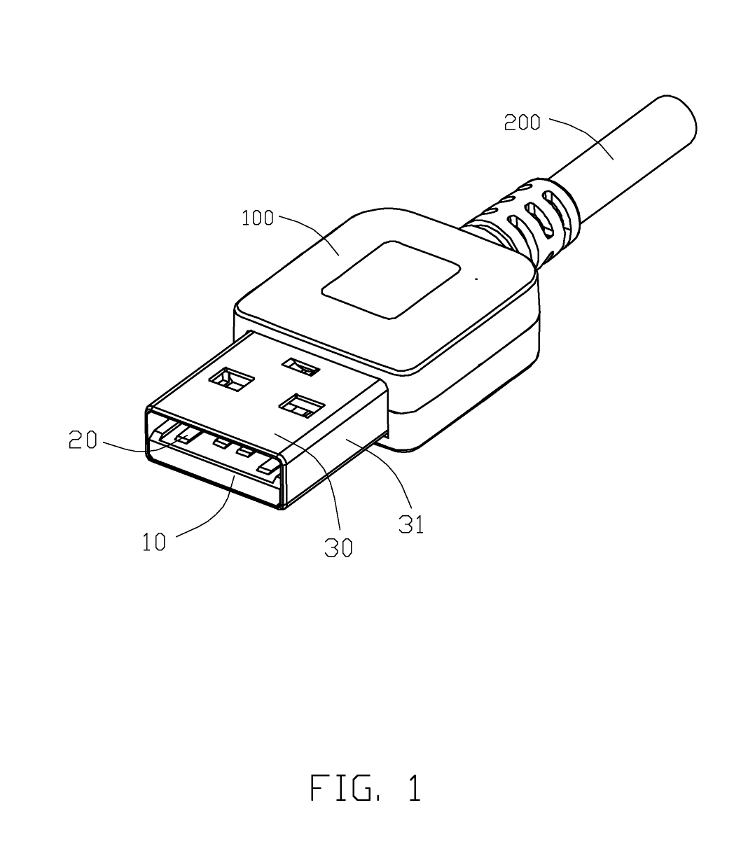

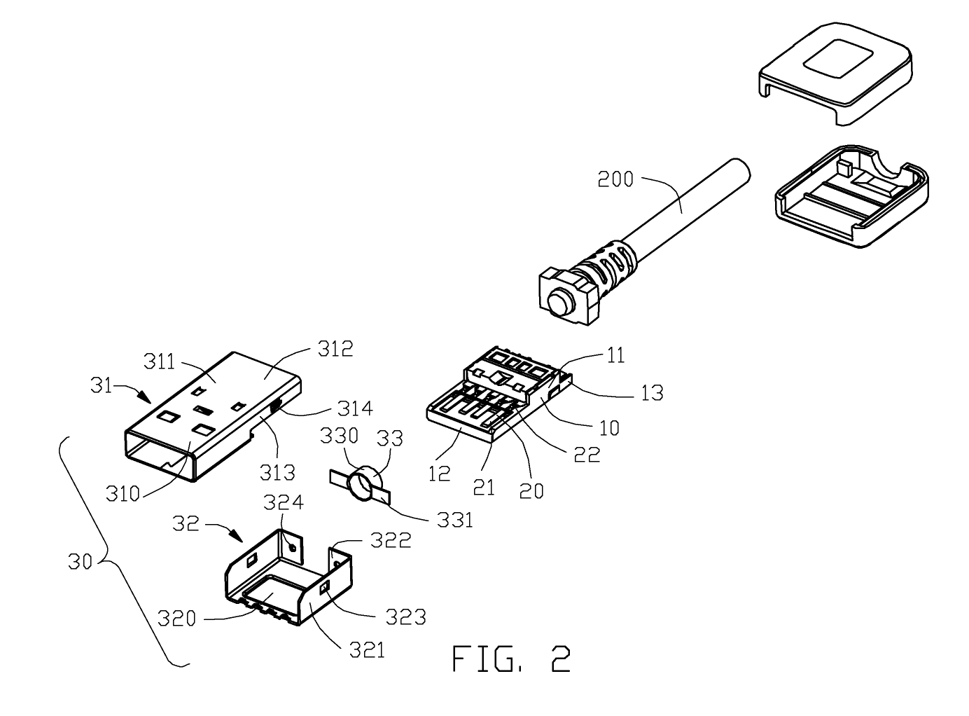

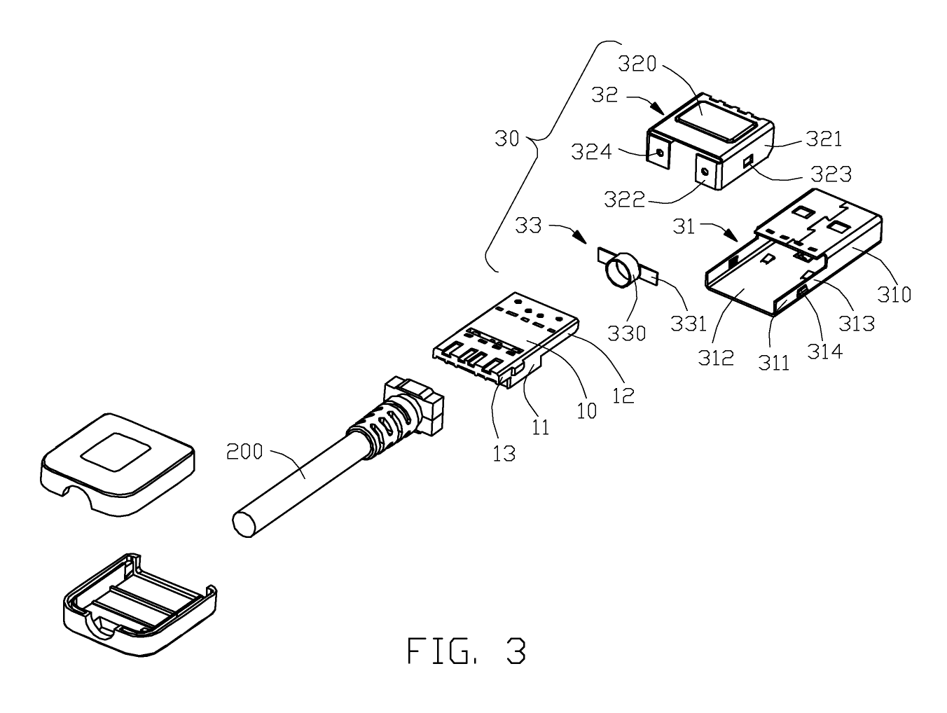

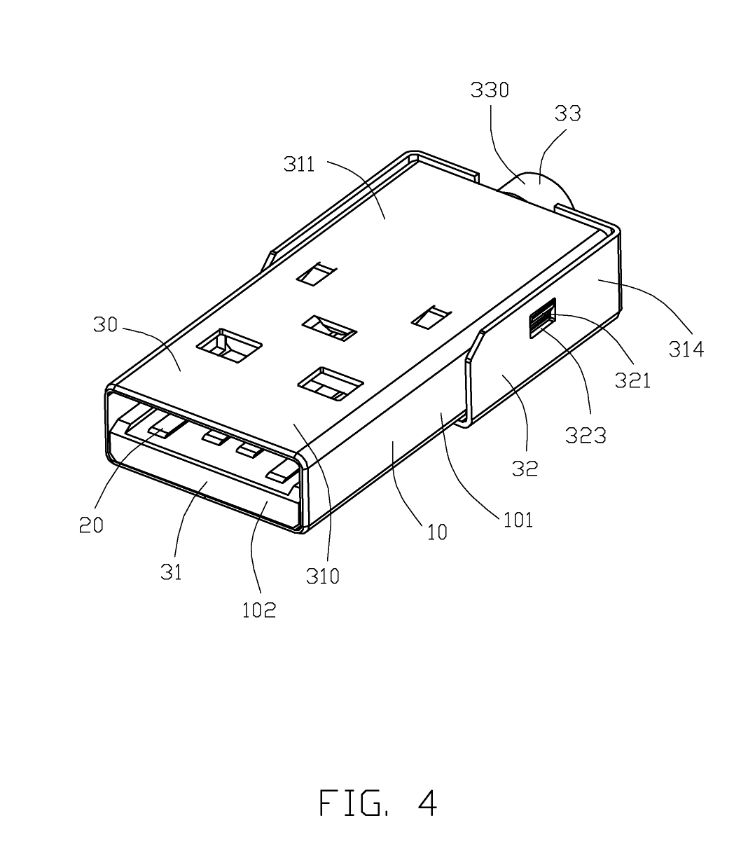

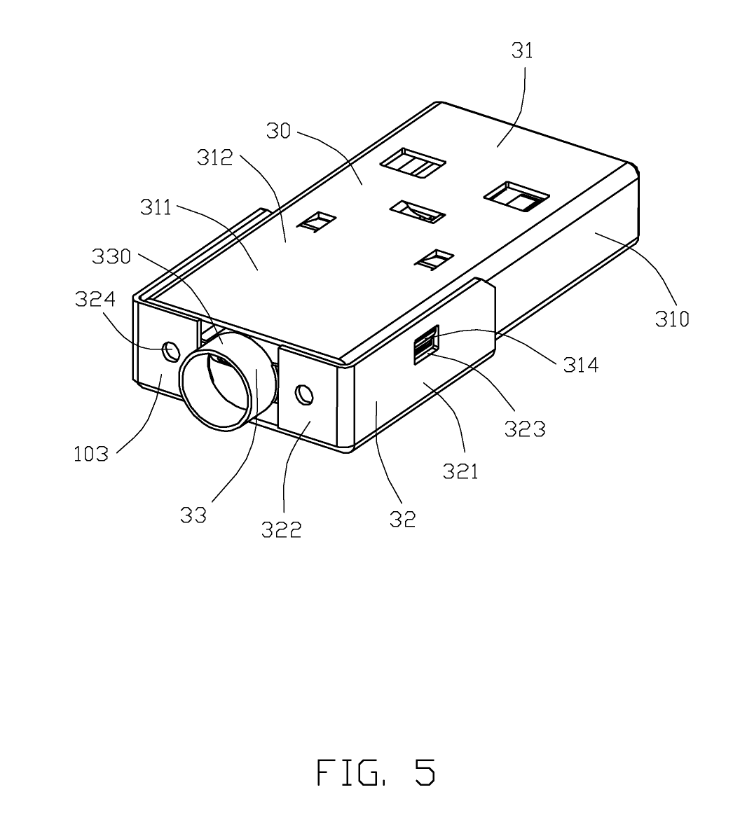

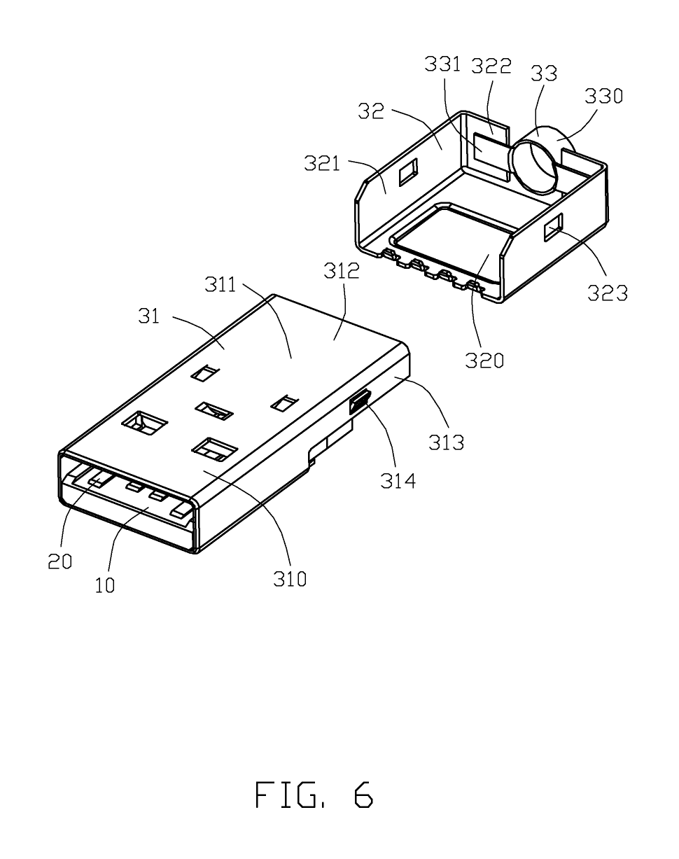

Referring to FIGS. 1 to 6, an electrical connector 100 having an end connected with a cable 200, comprises an insulative housing 10, a plurality of contacts 20 mounted on the insulative housing 10, and a metal shell 30 enclosing the insulative housing 10. The insulative housing 10 comprises a front face 102, a rear face 103 opposite to the front side 102, and a plurality of side faces 101 connected between the front face 102 and the rear face 103. The metal shell 30 comprises a first metal shell 31, a second metal shell 32, and a third metal shell 33 cooperated to seal gaps formed between the insulative housing 10 and the cable 200 and between the metal shell 30 and the cable 200. In this embodiment, the electrical connector 100 is in according with the USB type A 3.1 standard which speed can reach 10 Gbps per channel.

The insulative housing 10 comprises a base portion 11, a tongue portion 12 extending forwardly from the base portion 11, and a supporting portion 13 extending rearwardlly form the base portion 11. The tongue portion 12 is thinner than the base portion 11. The supporting portion 13 is thinner than the base portion 11.

The contacts 20 comprises a plurality of first set contacts 21 for transmitting USB 2.0 signal, and a plurality of second set contacts 22 disposed at a rear portion of the first set contacts 21 for transmitting high speed signal up to 10 Gbps per channel.

The first metal shell 31 comprises a front portion 310 having a closed side face, and a rear portion 311 connected with the front portion having an opened side face. The rear portion comprises a top wall 312, a pair of first side walls 313 extending downwardly from respective side edges of the top wall 312. Each of the first side walls 311 comprises a latch tab 314.

The second metal shell 32 comprises a bottom wall 320, a pair of second side walls 321 extending upwardly from respective side edges of the bottom walls 320, and a pair of extending portions 322 extending from respective rear ends of the second side walls 321. The extending portions 322 extend along a direction toward each other and spaced apart from each other. The extending portions 322 also can be designed in the first metal shell 31, or one extending portion 322 designed in the first metal shell 31 while the other extending portion 322 designed in the second metal shell 32. Each of the second side walls 321 defines a latch hole 323 latched with the latch tab 314. Each of the extending portions 322 defines a through hole 324. The second metal shell 32 is mated with the rear portion 311 of the first metal 31 along a top to bottom direction. The first metal shell 31 and the second metal shell 32 are cooperated to enclose the side faces 101 of the insulative housing 10.

The third metal shell 3 comprises a circled portion 330 for the cable 200 being inserted through, and a pair of side portions 331 extending along opposite directions from the circled portion 330. A distance between the two extending portions 322 is greater than or equal to an outer diameter of the circled portion 330. The side portions 331 and the extending portions 322 are cooperated to seal the rear face 103 of the insulative housing 10. The side portions 331 are disposed between the extending portions 322 and the insulative housing 10. The side portions are soldered with the extending portions 322 by the through hole 324. Therefore, the first metal shell 31, the second metal shell 32, and the third metal shell 331 are cooperated to seal gaps between the insulative housing 10 and the cable 200 and between the metal shell 30 and the cable 200.

A linear distance between the front face 102 and the rear end of the circled portion 30 is smaller than or equal to 27.2 mm, which is smaller than a distance substantially equal to 37.8 mm of a traditionary two pieces shell of USB 3.0 A type cable connector.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector with an end connected with a cable, comprising:
an insulative housing comprising a front face, a rear face, and a plurality of side faces;
a plurality of contacts mounted to the insulative housing; and
a metal shell enclosing the insulative housing, the metal shell comprising a first metal shell, a second metal shell, and a third metal shell cooperated to seal gaps between the insulative housing and the cable;
wherein the first metal shell and the second metal cooperate to enclose the side faces; and
wherein one of the first and the second metal shells comprises at least one extending portion disposed at a rear portion of the insulative housing, and the third metal shell comprises a circled portion for the cable to extend through and at least one side portion extending from the circled portion, the at least one extending portion and the at least one side portion cooperating to seal some of the gaps formed at a rear of the insulative housing.

2. The electrical connector as recited in claim 1, wherein there are two extending portions extending along a direction toward each other and spaced apart from each other.

3. The electrical connector as recited in claim 2, wherein a distance between the two extending portions is greater than or equal to an outer diameter of the circled portion.

4. The electrical connector as recited in claim 2, wherein there are two side portions extending along opposite directions from the circled portion.

5. The electrical connector as recited in claim 1, wherein the at least one side portion is disposed between the at least one extending portion and the insulative housing.

6. The electrical connector as recited in claim 5, wherein the at least one extending portion defines a through hole and is soldered with the at least one side portion by way of the through hole.

7. The electrical connector as recited in claim 1, wherein a linear distance between the front face and the rear end of the circled portion is smaller than or equal to 27.2 mm.

8. The electrical connector as recited in claim 1, wherein the first metal shell is latched with the second metal shell along a top to bottom direction.

9. A cable connector assembly comprising:
an insulative housing equipped with a plurality of contacts extending along a front-to-back direction;
a cable enclosing a plurality of wires, which are connected to the contacts, and rearwardly extending around a rear side of the housing;
a first metallic shell including a front portion surrounding the housing, and a rear portion which is opened one side in a vertical direction perpendicular to said front-to-back direction while cooperating with a second metallic shell to enclose the rear side of the housing, said first metallic shell and said second metallic shell commonly forming a pair of rear walls spaced from each other with a space therebetween in a transverse direction perpendicular to both said front-to-back direction and said vertical direction; and
a third metallic shell discrete from said first metallic shell and said second metallic shell and having a cylindrical portion and a pair of side arm portions unitarily formed with each other, said cable extending through the cylindrical portion and crimped by said cylindrical portion for securement thereof; wherein
the cylindrical portion is snugly received within the space between said pair of rear walls while the pair of side arm portions are secured to the corresponding pair of side arm portions, respectively, in the front-to-back direction.

10. The cable connector assembly as claimed in claim 9, wherein the pair of rear walls lie in a vertical plane perpendicular to said front-to-back direction.

11. The cable connector assembly as claimed in claim 10, wherein an inner edge of each of said pair of rear walls extends in the vertical direction.

12. The cable connector assembly as claimed in claim 11, wherein said cable is equipped with a strain relief having a front face lying in a vertical plane.

13. The cable connector assembly as claimed in claim 10, further including a pair of insulative covers commonly enclosing the rear portion and the first metallic shell and the second metallic portion.

14. The cable connector assembly as claimed in claim 9, wherein said pair of rear walls are unitarily formed with the second metallic shell.

15. The cable connector assembly as claimed in claim 14, wherein said pair of rear walls extending from a main body of the second metallic shell toward each other in the transverse direction.

16. A cable connector assembly
an insulative housing;
a plurality of contacts disposed in the housing along a front-to-back direction and arranged with one another in a transverse direction perpendicular to said front-to-back direction;
a first metallic shell including a front portion enclosing a front section of the housing, and a rear portion originally opened in one side along a vertical direction, which is perpendicular to both said front-to-back direction and said transverse direction while cooperating with a second metallic shell to enclose a rear portion of the housing;
said first metallic shell cooperating with said second metallic shell to commonly form a pair of rear walls spaced from each other with a space therebewteen in the transverse direction;
a third metallic shell discrete from both said first metallic shell and said second metallic shell and including a tubular section and pair of side portions unitarily wherein the tubular section is received within the space and the pair of side portions are overlapped with the pair of rear walls in the front-to-back direction, respectively; and
a cable enclosing a plurality of wires mechanically and electrically connected to the corresponding contacts, respectively, and extending rearwardly through and crimped by the tubular section.

17. The cable connector assembly as claimed in claim 16, wherein said insulative housing defines a first length along a front-to-back direction, and said first metallic shell and said second metallic shell commonly define a second length along the front-to-back direction, said first length being around two thirds of the second length.

18. The cable connector assembly as claimed in claim 16, wherein said cable is equipped with an enlarged strain relief having a forwardly confrontation vertical face.

19. The cable connector assembly as claimed in claim 16, wherein said pair of side portions are secured to the corresponding pair of rear walls, respectively.

20. The cable connector assembly as claimed in claim 16, wherein said pair of side portions are dimensioned larger than the tubular section in the vertical direction.
